(19) United States
(12) Patent Application Publication
(10) Pub. No.: US 2026/0021732 A1
(43) Pub. Date: Jan. 22, 2026

(54) CHARGING SYSTEM

(71) Applicant: TOYOTA JIDOSHA KABUSHIKI KAISHA, Toyota-shi Aichi-ken (JP)

(72) Inventors: Hironaga ONO, Toyota-shi Aichi-ken (JP); Ritsu NISHIMURA, Nagoya-shi Aichi-ken (JP); Hiroaki NISHINO, Toyota-shi Aichi-ken (JP); Yohei ONO, Nisshin-shi Aichi-ken (JP); Ryohei CHINO, Nisshin-shi Aichi-ken (JP); Shimpei ISOBE, Toyota-shi Aichi-ken (JP); Manabu HIROSE, Okazaki-shi Aichi-ken (JP)

(73) Assignee: TOYOTA JIDOSHA KABUSHIKI KAISHA, Toyota-shi Aichi-ken (JP)

(21) Appl. No.: 19/268,216

(22) Filed: Jul. 14, 2025

(30) Foreign Application Priority Data
Jul. 19, 2024 (JP) 2024-115846

(51) Int. Cl. B60L 53/37; B60L 53/16; B60L 53/30; B60L 53/31; G06T 7/00

(52) U.S. Cl. CPC B60L 53/37; B60L 53/16; B60L 53/305; B60L 53/31; G06T 7/0002; G06T 2207/30252; G06T 2207/30268

(57) ABSTRACT

A charging system includes: a charging device including a charging connector; an arm mechanism configured to grip the charging connector; an imaging device provided on the arm mechanism; a mirror provided in the charging device or the arm mechanism; and an abnormality detecting device configured to capture an image of the charging connector reflected in the mirror using the imaging device, and detect an abnormality of the charging connector using the captured image.

### CROSS-REFERENCE TO RELATED APPLICATIONS

The present application claims priority to and incorporates by reference the entire contents of Japanese Patent Application No. 2024-115846 filed in Japan on Jul. 19, 2024.

### BACKGROUND

The present disclosure relates to a charging system.

JP 2023-79759, discloses a charging system which determines whether a charging cable satisfies a predetermined safety conditions such as not intruding into a charging compartment when inserting a charging connector to a charging port of a vehicle.

### SUMMARY

In the charging system described in JP 2023-79759, it may not detect abnormality of the charging system such as cracking of the charging connector.

There is a need for a charging system capable of detecting abnormality of the charging system such as cracking of a charging connector.

According to one aspect of the present disclosure, there is provided a charging system including: a charging device including a charging connector; an arm mechanism configured to grip the charging connector; an imaging device provided on the arm mechanism; a mirror provided in the charging device or the arm mechanism; and an abnormality detecting device configured to capture an image of the charging connector reflected in the mirror using the imaging device, and detect an abnormality of the charging connector using the captured image.

### BRIEF DESCRIPTION OF THE DRAWINGS

FIG. 1 is a block diagram showing a configuration of a charging system according to an embodiment;

FIG. 2 is a schematic diagram showing an appearance of a charging system according to the embodiment; and

FIG. 3 is a flowchart illustrating a flow of abnormality detection processing according to the embodiment.

### DETAILED DESCRIPTION

Hereinafter, a charging system according to an embodiment will be described with reference to the drawings.

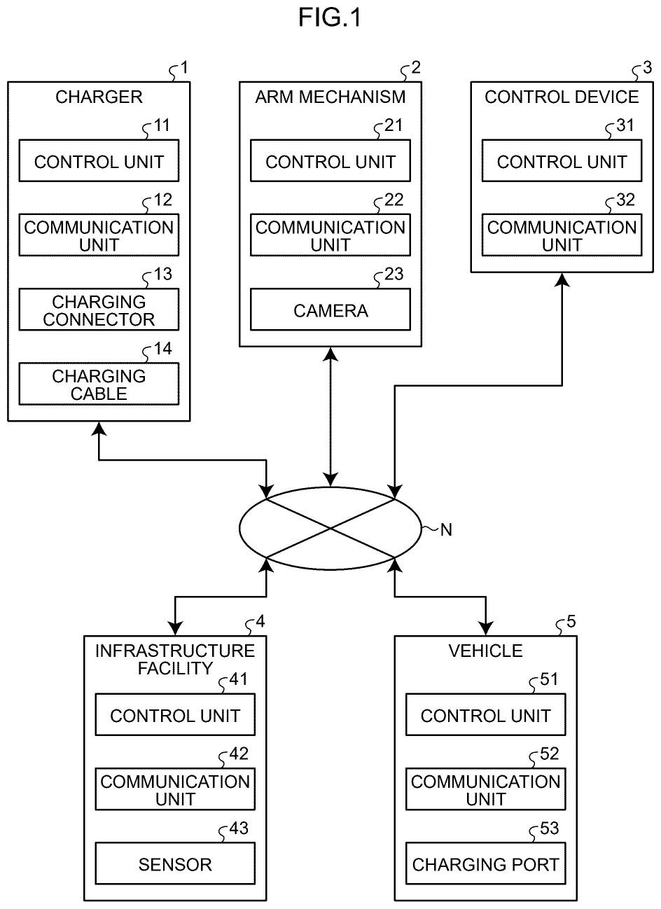

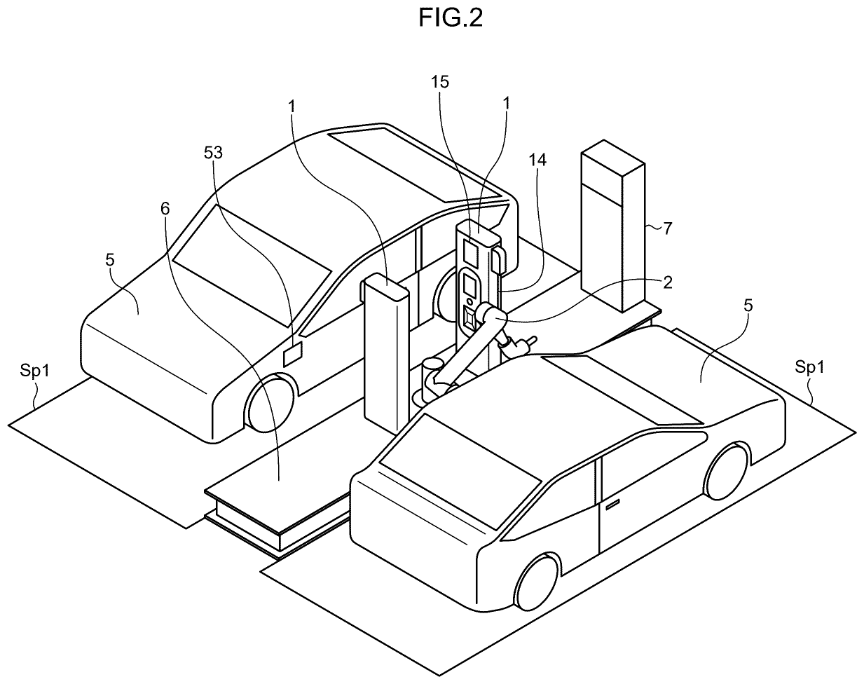

First, with reference to FIGS. 1 and 2, a description will be given of a configuration of a charging system according to an embodiment of the present disclosure. FIG. 1 is a block diagram showing a configuration of a charging system according to an embodiment of the present disclosure. FIG. 2 is a schematic diagram showing an appearance of a charging system according to an embodiment of the present disclosure.

A charging system according to the embodiment is for charging a plurality of vehicles at the same time using a charger installed in a site such as a parking lot, for example, as shown in FIG. 1, a charger 1, an arm mechanism 2, a control device 3, an infrastructure facility 4, and a vehicle 5. The charger 1, the arm mechanism 2, the control device 3, the infrastructure facility 4, and the vehicle 5 are all provided with a communication function, it is configured to be able to exchange various information by communicating with each other through the network N. The network N is composed of, for example, an Internet line network or a mobile phone line network.

The charger (charging station, charging post) 1 is for supplying power to the vehicle 5 to be charged. As shown in FIG. 2, the charger 1, while being installed on the frame 6, is connected to a control panel 7.

The control panel 7 is connected to a substation facility (cubicle) or the like for transforming power from a power plant, for example. A frame 6, for example, is installed in a parking lot or the like capable of integrating the vehicle 5. The frame 6, regardless of the type of parking, for example flat parking, mechanical steric parking, it is possible to install in any parking such as a self-propelled multilevel parking lot. Further, the frame 6, the charger 1, the arm mechanism 2, and the control panel 7 is disposed. Further, in the present embodiment, two chargers 1 are installed on the frame 6, it is configured to be charged simultaneously for two or more vehicles 5.

When the charger 1 is installed in a parking lot, it shall be installed on a frame basis. That is, the charger 1 in the frame 6 in advance such as a factory, the arm mechanism 2, and the control panel 7 is installed, the adjustment of the operation of the arm mechanism 2 (robot teaching), the alignment of the charger 1 and the arm mechanism 2, after completing the wiring work or the like, installed by transporting the frame 6 in the parking lot (e.g. anchor fixing). By performing the installation in such a frame unit, with the degree of freedom in installation of the charger 1 and the arm mechanism 2 is improved, it is possible to minimize the construction cost.

Return to FIG. 1. The charger 1 includes a control unit 11, communication unit 12, charging connector 13, charging cable 14, and a mirror 15 (see FIG. 2).

The control unit 11 is constituted by, for example, a processor made of a central processing unit (CPU) or the like, and a memory (main storage unit) consisting of a random-access memory (RAM) and a read only memory (ROM) or the like. The control unit 11, based on an instruction from the control unit 3, supplies power to the vehicle 5 to be charged.

The communication unit 12 is composed of, for example, a local area network (LAN) interface board, a wireless communication circuitry or the like for wireless communication. The communication unit 12 communicates with, for example, the arm mechanism 2 and the control device 3 via the network N.

The charging connector (charging gun, charging plug) 13 supplies power to the vehicle 5 to be charged. The charging connector 13 is engaged with the side surface of the charger 1 during non-charging. Then, the charging connector 13, when the start of charging to the vehicle 5 is started, it is grasped by the arm mechanism 2 of the fixed type, is inserted into the charging port 53 of the vehicle 5. In this state, through the charging connector 13, power is supplied from the charger 1 side to the vehicle 5 side. Thereafter, when charging to the vehicle 5 is completed, the charging connector 13 is again grasped by the arm mechanism 2, after being withdrawn from the charging port 53 of the vehicle 5 is engaged with the side surface of the charger 1. FIG. 2 illustrates an example in the case where one charging connector 13 is provided for one charger 1, a plurality of charging connector 13 for one charger 1 may be provided.

Return to FIG. 1. The charging cable 14 is provided between the charging connector 13 and the charger 1 (charger body). The charging cable 14, regardless of the position of the charging port 53 in the vehicle 5 is constituted by a length capable of inserting the charging connector 13 into the charging port 53. Depending on the vehicle type, the charging port 53 is left rear of the vehicle 5, the center front, in some cases are arranged at the center rear or the like. Therefore, the charging cable 14, the left front of the charging port 53 of the vehicle 5, the left rear, the center front, even when it is arranged in any of the center rear, the charging connector 13 is configured in a length that may be inserted.

As illustrated in FIG. 2, the mirror 15 is installed on the outer surface of the charger 1, the installation position so that the charging port 53 of the vehicle 5 during charging is captured, the size, and the angle are adjusted. In the present embodiment the mirror 15 has installed in the charger 1 but the mirror 15 may be installed in the arm mechanism 2. However, even in this case, the installation position of the mirror 15, the size, and the angle is assumed to be adjusted so that the charging port 53 of the vehicle 5 during charging is captured.

Return to FIG. 1. The arm mechanism (automatic charging robot) 2, when performing charging from the charger 1 to the vehicle 5 is for gripping the charging connector 13. The arm mechanism 2 is installed and fixed to the frame 6. The arm mechanism 2 includes a control unit 21, a communication unit 22, and a camera 23.

The control unit 21 is constituted by, for example, a processor made of CPU or the like, and a memory (main storage unit) made of RAM or ROM.

The control unit 21, based on an instruction from the control unit 3, grasps the charging connector 13, and insertion of the charging connector 13 to the charging port 53, and withdrawal of the charging connector 13 from the charging port 53.

The control unit 21 identifies the position of the charging port 53, the charging port 53 the distance to (the distance between the charging connector 13 and the charging port 53) when inserting the charging connector 13 which is gripped into the charging port 53, for example, from the image captured by the camera 23 installed at the tip of the arm mechanism 2. The shape of the charging port 53 of the vehicle 5 is normalized. Therefore, the position of the charging port 53 may be identified by performing pattern matching based on the image of the charging port 53 captured by the camera 23. Further, the distance from the charging connector 13 which the arm mechanism 2 is grasped to the charging port 53, using a 3D (three-dimensional) camera as the camera 23, by acquiring information in the depth direction, it may be specified.

The communication unit 22 is composed of, for example, a LAN interface board, a wireless communication circuit or the like for wireless communication. The communication unit 22 communicates with, for example, the charger 1 and the control device 3 through the network N.

The camera 23 is for use when the abnormality detection process to be described later with imaging the charging port 53. The camera 23 is provided at the tip of the arm mechanism 2 (arm mechanism body). In embodiments, the camera 23 may be a 3D camera capable of acquiring information in the depth direction.

The controller 3 is for controlling the charger 1, the arm mechanism 2, and a plurality of vehicles 5, for example, charging control of the charger 1, the control of the operation of the arm mechanism 2, the control of the infrastructure facility 4, the traveling control of the vehicle 5, the charging system such as the charging connector 13 It performs abnormality detection or the like. The controller 3 is composed of a general-purpose computer such as a workstation or a personal computer, or a server disposed on a cloud. The controller 3 may be constituted by separate hardware in accordance with the control target (charger 1, arm mechanism 2, infrastructure facility 4, vehicle 5). Further, the control panel 7 may be responsible for a function of the control device 3 which performs charging control of the charger 1. The control device 3 functions as an abnormality detecting device according to the present disclosure.

The controller 3 includes a control unit 31 and the communication unit 32.

The control unit 31 is constituted by, for example, a processor made of CPU or the like, and a memory (main storage unit) made of RAM or ROM. The following describes the specific processing contents of the control unit 31.

The control unit 31, based on the information obtained from the infrastructure facility 4 (e.g., position information of the vehicle 5, etc.), performs travel control of the vehicle 5. For example, the control unit 31 receives the charging reservation of the vehicle 5 from the user of the vehicle 5 (e.g., the driver). The charging reservation may be accepted based on information input to the information terminal possessed by the user (for example, a smartphone or the like connected to the network N), or may be accepted based on information input to the in-vehicle terminal (for example, a car navigation or the like connected to the network N) by the user.

When the order of charging of the vehicle 5 is approaching, the control unit 31, by using the positional information or the like of the vehicle 5 acquired from the infrastructure facility 4, the vehicle 5 from the parking space in which the vehicle 5 is parked after automatically traveling to the standby space, it is automatically parked. Thus, by waiting to move the vehicle 5 to be charged to the standby space in advance, to minimize the replacement time of the vehicle 5 to perform charging, it is possible to improve the operation rate of the charger 1.

Subsequently, when the order of charging the vehicle 5 arrives, the control unit 31, using the positional information and the like of the vehicle 5 acquired from the infrastructure facility 4, after automatically traveling the vehicle 5 from the standby space to the charging space Sp1 (see FIG. 2), to automatically park. Then, the control unit 31 grasps the charging connector 13 by the arm mechanism 2, to insert the charging connector 13 into the charging port 53, to start charging by the charger 1.

Subsequently, when the charging of the vehicle 5 is completed, the control unit 31 is a charging connector 13 again grasped by the arm mechanism 2, to withdraw the charging connector 13 from the charging port 53. Subsequently, the control unit 31 uses the positional information of the vehicle 5 acquired from the infrastructure facility 4, after automatically traveling the vehicle 5 from the charging space Sp1 to the standby space, to automatically park.

The control unit 31, when parking the vehicle 5 in the charging space Sp1, the charging port 53 is parked so as to face the charger 1. Then, the control unit 31, using a single arm mechanism 2, simultaneously charging two or more vehicles 5. Thus, it is possible to increase the rotation rate of charging.

The communication unit 32 includes, for example, a LAN (Local Area Network) interface board, a wireless communication circuitry for wireless communication, and the like. The communication unit 32 communicates with, for example, the charger 1, the arm mechanism 2, the infrastructure facility 4, and the vehicle 5 through the network N.

The infrastructure facility 4 is for realizing, for example, automatic travel of the vehicle 5 in the parking lot, and automatic parking by advanced parking (advanced parking support function). The infrastructure facility 4, around the charging space Sp1 of the vehicle 5, around the standby space of the vehicle 5, on the traveling route of the vehicle 5 (such as on both sides of the traveling route) and the like are arranged.

The infrastructure facility 4 includes a control unit 41, communication unit 42, and a sensor 43.

The control unit 41 is realized by, for example, a processor made of a CPU or the like, and a memory made of RAM or ROM or the like (main storage unit). The control unit 41, for example, information about the position of the vehicle 5 detected by the sensor 43 and the like, and transmits to the control device 3.

The communication unit 42 is constituted by, for example, a LAN (Local Area Network) interface board, a wireless communication circuitry for wireless communication, and the like. The communication unit 42, by communication via the network N, for example, exchanges information with the control device 3 and the vehicle 5.

The sensor 43 is constituted by, for example, a LiDAR (Light Detection and Ranging, Laser Imaging Detection and Ranging), a camera or the like.

The vehicle 5 is, for example, a plug-in hybrid vehicle (PHEV: Plug-in Hybrid Electric Vehicle), a chargeable electric vehicle such as an electric vehicle (BEV: Battery Electric Vehicle). The vehicle 5, for example, without operation by the driver, may be an autonomously travelable automated driving vehicle. Further, the vehicle 5 automatically parking or automatic parking function may be provided with a parking assist function for assisting the parking.

The vehicle 5 includes a control unit 51, a communication unit 52, and a charging port 53. In FIG. 1, among the configurations of the vehicle 5, only the configuration for realizing the power supply system according to the embodiment is illustrated, and other configurations are not shown.

The control unit 51 is, for example, an electronic control unit including a microcomputer consisting of a CPU, RAM, ROM or the like as main components (Electronic Control Unit: ECU). The control unit 51 comprehensively controls the operation of various components of the vehicle 5 by executing various programs.

The control unit 51, based on an instruction from the control device 3, for example, performs automatic travel and automatic parking in the parking lot. For example, the user of the vehicle 5, when the charging reservation by the charger 1 operates the vehicle 5 to the parking lot in which the charger 1 is installed, to park in the parking space in the parking lot. Then, the user opens the cover of the charging port 54 when getting off the vehicle 5 (hereinafter, referred to as “charging port cover”) and leaves the parking space.

When the order of charging the vehicle 5 is approaching, the control unit 51, in accordance with an instruction from the control unit 3, after automatically traveling the vehicle 5 from the parking space to the standby space, to automatically parking. Subsequently, when the order of charging the vehicle 5 arrives, the control unit 51, in accordance with an instruction from the control unit 3, after automatically traveling the vehicle 5 from the standby space to the charging space Sp1, to automatically park. Then, the charging connector 13 grasped by the arm mechanism 2 is inserted into the charging port 53, charging is started.

Subsequently, when the charging is completed, the charging connector 13 is withdrawn from the charging port 53 by the arm mechanism 2. Subsequently, the control unit 51, in accordance with an instruction from the control unit 3, after automatically traveling the vehicle 5 from the charging space Sp1 to the standby space, to automatically park.

The communication unit 52 is composed of, for example, a data communication module (DCM) or the like. The communication unit 52 communicates with, for example, the charger 1, the arm mechanism 2, the control device 3, and the infrastructure facility 4 through the network N.

The charging port (inlet) 53 is for receiving power from the charger 1. The charging port 53, by the charging connector 13 of the charger 1 is inserted, the power from the charger 1, to store the battery of the vehicle 5 (not shown).

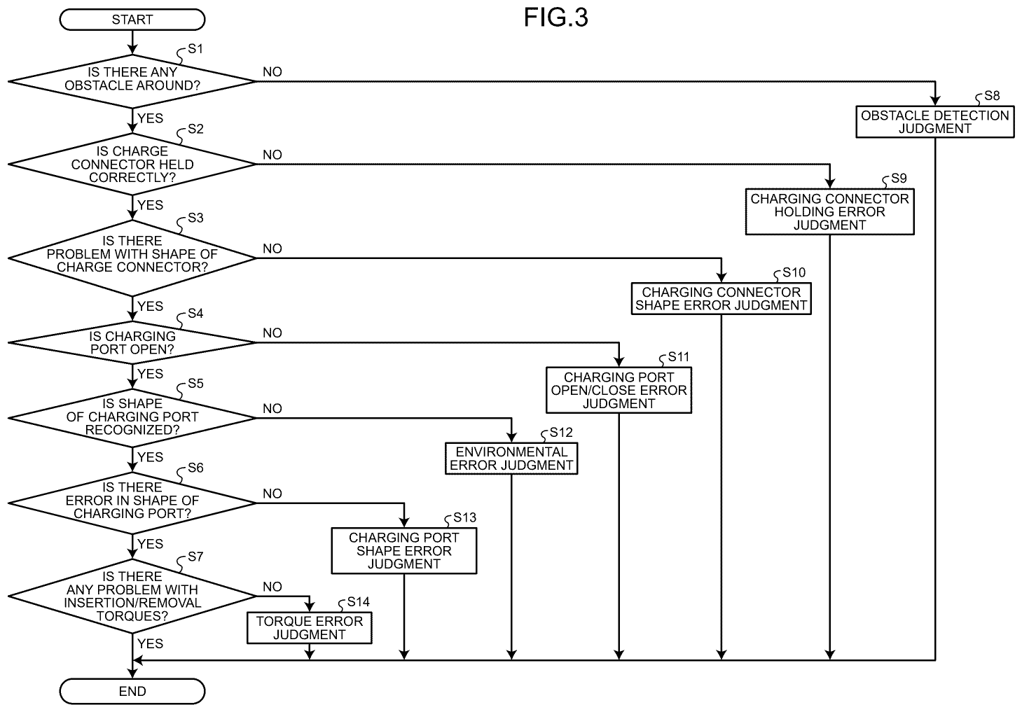

In the charging system having such a configuration, by the control device 3 executes the abnormality detection process shown below, detects an abnormality of the charging system such as a crack of the charging connector 13. Hereinafter, with reference to the flowchart shown in FIG. 3, the operation of the control device 3 when executing the abnormality detection process. The control device 3 corresponds to the abnormality detecting device according to the present disclosure.

FIG. 3 is a flowchart illustrating a flow of abnormality detection processing according to an embodiment of the present disclosure. The process starts at the timing of the parking the vehicle 5 to be charged in the charging space Sp1, the abnormality detection process proceeds to the process of the step S1.

In the process of the step S1, the control device 3 takes an image of the periphery of the vehicle 5 to be charged by using the camera 23 provided with the arm mechanism 2, it is determined whether there is an obstacle around the vehicle 5 based on the captured image.

As a result of the determination, when there is no obstacle around the vehicle 5 (step S1: Yes), the control device 3 advances the abnormality detection process to the process of the step S2. On the other hand, if there is an obstacle around the vehicle 5 (step S1: No), the control device 3 advances the abnormality detection process to the process of step S8.

In the process of step S2, the control device 3 takes a charge connector 13 which photographs the mirror 15 by using the camera 23 having the arm mechanism 2, the arm mechanism 2 based on the captured image to determine whether correctly hold the charging connector 13. Specifically, the control device 3 stores the image of the charging connector 13 at the time of normal to be captured in the mirror 15, by executing a template matching to compare the stored image with the captured image, the arm mechanism 2 to determine whether correctly hold the charging connector 13. The controller 3 detects each axial torque of the arm mechanism 2, the arm mechanism 2 based on the detected torque may be determined whether correctly holding the charging connector 13. As a result of the determination, if the arm mechanism 2 is holding the charge connector 13 correctly (step S2: Yes), the control device 3 advances the abnormality detection process to the process of step S3. On the other hand, if the arm mechanism 2 is not holding the charge connector 13 correctly (step S2: No), the control device 3 advances the abnormality detection process to the process of step S9.

In the process of the step S3, the control device 3 determines whether or not there is an abnormal shape of the charge connector 13 (such as a clogging of foreign matter or a bent pin) on the basis of images taken in the process of the step S2. Specifically, the control device 3 stores the image of the charging connector 13 at the time of normal captured on the mirror 15, by executing a template matching to compare the stored image and the captured image, the charging connector 13 to determine whether there is an abnormality in shape. As a result of the determination, if there is no abnormality in the shape of the charge connector 13 (step S3: Yes), the control device 3 advances the abnormality detection process to the process of step S4. On the other hand, if there is an abnormality in the shape of the charge connector 13 (step S3: No), the control device 3 advances the abnormality detection process to the process of step S10.

In the process of the step S4, the control device 3 captures an image of the charging port 53 of the vehicle 5 to be charged using the camera 23 provided in the arm mechanism 2, the vehicle 5 based on the captured image to determine whether the cover of the charging port 53 is open. As a result of the determination, if the cover of the charging port 53 of the vehicle 5 is open (step S4: Yes), the control device 3 advances the abnormality detection process to the process of the step S5. On the other hand, if the cover of the charging port 53 of the vehicle 5 is not open (step S4: No), the control device 3 advances the abnormality detection process to the process of step S11.

In the process of the step S5, the control device 3 captures an image of the charging port 53 of the vehicle 5 to be charged by using the camera 23 provided with the arm mechanism 2, the conditions of the surrounding environment such as solar radiation conditions based on the captured image to determine whether or not it is possible to recognize the shape of the charging port 53 of the vehicle 5 without being affected. As a result of the determination, if it may recognize the shape of the charging port 53 of the vehicle 5 (step S5: Yes), the control device 3 advances the abnormality detection process to the process of the step S6. On the other hand, when the shape of the charging port 53 of the vehicle 5 has not been recognized (step S5: No), the control device 3 advances the abnormality detection process to the process of step S12.

In the process of the step S6, the control device 3 takes an image of the charging port 53 of the vehicle 5 to be charged using the camera 23 provided in the arm mechanism 2, the shape of the charging port 53 of the vehicle 5 based on the captured image to determine whether there is an abnormality. As a result of the determination, if there is no abnormality in the shape of the charging port 53 of the vehicle 5 (step S6: Yes), the control device 3 advances the abnormality detection process to the process of step S7. On the other hand, if there is an abnormality in the shape of the charging port 53 of the vehicle 5 (step S6: No), the control device 3 advances the abnormality detection process to the process of step S13.

In the process of the step S7, the control device 3, the torque when pulling out the charging connector 13 from the charging port 53 of the time and the vehicle 5 to insert the charging connector 13 to the charging port 53 of the vehicle 5 by utilizing the torque sensor incorporated in the arm mechanism 2 is determined whether within the normal range. As a result of the determination, if the torque is within the normal range (S7: Yes), the control device 3 ends the series of abnormality detection process. On the other hand, if the torque is not within the normal range (step S7: No), the control device 3 advances the abnormality detection process to the process of step S14.

In the process of S8 of steps, the control device 3 turns on the obstacle detection determination flag indicating that an obstacle exists around the vehicle 5, and notifies that an obstacle exists around the vehicle 5. Thus, the process of S8 of steps is completed, a series of abnormality detection process is completed.

In the process of step S9, the control unit 3, the arm mechanism 2 is to turn on the charging connector holding abnormality determination flag indicating that does not hold correctly the charging connector 13, the arm mechanism 2 to notify that not hold correctly the charging connector 13. Thus, the process of step S9 is completed, a series of abnormality detection process is completed.

In the process of step S10, the control unit 3, with turning on the charging connector shape abnormality determination flag indicating that there is an abnormality in the shape of the charging connector 13, to notify that there is an abnormality in the shape of the charging connector 13. Thus, the process of Step S10 is completed, a series of abnormality detection process is completed.

In the process of Step S11, the control device 3, with turning on the charging port opening and closing abnormality determination flag indicating that the cover of the charging port 53 is not open, to notify that the cover of the charging port 53 is not open. Thus, the process of Step S11 is completed, a series of abnormality detection process is completed.

In the process of Step S12, the control unit 3, with turning on the environmental abnormality determination flag indicating that may not recognize the shape of the charging port by environmental factors, to notify that may not recognize the shape of the charging port by environmental factors. Thus, the process of Step S12 is completed, a series of abnormality detection process is completed.

In the process of Step S13, the control unit 3, with turning on the charging port shape abnormality determination flag indicating that abnormality has occurred in the shape of the charging port 53, notifying that abnormality has occurred in the shape of the charging port 53. Thus, the process of Step S13 is completed, a series of abnormality detection process is completed.

In the process of Step S14, the control unit 3, with turning on the torque abnormality determination flag indicating that an abnormality in torque has occurred to notify that an abnormality in torque has occurred. Thus, the process of Step S14 is completed, a series of abnormality detection process is completed.

As apparent from the above description, the charging system according to the embodiment includes the charger 1 having the charging connector 13, the gripping capable arm mechanism 2, the charging connector 13, the camera 23 provided on the arm mechanism 2, the mirror 15 provided in the charger 1 or the arm mechanism 2, using the camera 23 captures an image of the charging connector 13 which is captured by the mirror 15, the control device 3 for detecting an abnormality of the charging connector 13 using the captured image. Thus, it is possible to detect abnormality of the charging system such as cracking of the charging connector 13.

Further, in the present embodiment, the control device 3 captures an image of the charging port 53 of the vehicle 5 which appears in the mirror 15 using the camera 23, detects the abnormality of the charging port 53 using the captured image. Thus, the abnormality of the vehicle 5 side of the charging target may also be detected.

Further, in the present embodiment, the control device 3 detects the abnormality of the charging connector 13 by comparing the image of the charging connector 13 captured by using the camera 23 and the normal image of the charging connector 13. Thus, the abnormality of the charging connector 13 may be accurately detected.

Although the embodiments to which the disclosure has been applied have been described, the disclosure is not limited by the description and drawings that form a part of the disclosure of the disclosure according to the embodiments. For example, the control device 3 captures an image of the interior of the vehicle 5 that is not being charged is performed parked in the charging space Sp1 by using the camera 23 provided in the arm mechanism 2, car share or the like on the basis of the captured image it may be controlled so as to execute the necessary in-vehicle inspection and in-vehicle cleaning or the like. According to such a process, it is possible to effectively use the camera 23 even while the charging of the vehicle 5 is not performed. Further, the control device 3, thus, other embodiments made by those skilled in the art based on the present embodiment, examples, operation techniques, etc. are all included in the scope of the present disclosure.

According to the charging system according to the present disclosure, it is possible to detect abnormality of the charging system such as cracking of the charging connector.

What is claimed is:

1. A charging system comprising:
a charging device including a charging connector;
an arm mechanism configured to grip the charging connector;
an imaging device provided on the arm mechanism;
a mirror provided in the charging device or the arm mechanism; and
an abnormality detecting device configured to
capture an image of the charging connector reflected in the mirror using the imaging device, and
detect an abnormality of the charging connector using the captured image.

2. The charging system according to claim 1, wherein the abnormality detecting device is configured to capture an image of a charging port of a vehicle reflected in the mirror using the imaging device, and detect an abnormality of the charging port using the captured image.

3. The charging system according to claim 1, wherein the abnormality detecting device is configured to capture an image of an interior of a vehicle that is not being charged by the charging device using the imaging device, and inspect the interior of the vehicle based on the captured image.

4. The charging system according to claim 1, wherein the abnormality detecting device is configured to detect the abnormality of the charging connector by comparing the image of the charging connector captured by using the imaging device and a normal image of the charging connector.
